(19) United States
(12) Patent Application Publication
(10) Pub. No.: US 2008/0007001 A1
(43) Pub. Date: Jan. 10, 2008

(54) Geography and investment board game

(76) Inventors: Paul Bowen, Purchase, NY (US); Claudette Holder, Purchase, NY (US)

Correspondence Address: JAMES RAY & ASSOCIATES, 2640 PITCAIRN ROAD, MONROEVILLE, PA, 15146, US

(21) Appl. No.: 11/818,467

(22) Filed: Jun. 14, 2007

Related U.S. Application Data
(60) Provisional application No. 60/813,890, filed on Jun. 15, 2006.

(51) Int. Cl. G09B 3/00; A63F 3/00

(52) U.S. Cl. 273/242; 434/327

(57) ABSTRACT

An educational game apparatus for simulating investing in nations of a continent using a board is disclosed. The board has a multiplicity of triangular spaces forming a continuous path around the perimeter of the game board, and a map of a continent is disposed in a substantially central region of the board. A stack of investment cards each indicating a new value for a particular investment is included as part of the game. A plurality of stock value chips and at least two distinguishable player tokens for marking positions after moving along the continuous path are provided. Furthermore, there is a plurality of nation geography cards each containing at least one fact pertaining to the geography of a country of the continent. The game also includes a plurality of simulated paper currency in different denominations and a random number generator for randomly determining the number of spaces for individual players to move their player tokens.

### CROSS REFERENCE TO RELATED APPLICATION

This patent application is related to and claims priority from U.S. Provisional Patent Application Ser. No. 60/813,890 filed Jun. 15, 2006.

### FIELD OF THE INVENTION

The present invention relates, in general, to games for teaching geography and, more particularly, this invention relates to an educational board game that entails simulated investment in raw materials of the countries of Africa.

### BACKGROUND OF THE INVENTION

Prior to the conception and development of the present invention, children can become bored by conventional means of teaching geography. Games have long been recognized as one way to make learning more enjoyable. There are numerous patented games aimed at teaching geography, such as that in U.S. Pat. No. 4,988,108 which focuses on naming the capitals of states. The game taught by Desmarais in U.S. Pat. No. 5,150,907 involves a map and world travel routes. Levine in U.S. Pat. No. 7,121,549 teaches a game based on world geography and culture. U.S. Pat. No. 6,102,398 and British patent GB2211750 teach question and answer games utilizing a game board with a grid on a map.

There are many games that involve simulated investing, such as those disclosed by McGenis in U.S. Pat. No. 2,174,058, by Fischel in U.S. Pat. No. 4,856,788, and by Fikki in U.S. Pat. No. 6,322,076. It appears to be very rare, however, to combine the two elements of geography and investing. In U.S. Pat. No. 5,292,133, Alexander teaches an economics board game simulating importing and exporting to and from African countries. The playing path is circular with essentially only country spaces for the players to land on. Also, there is no mention of stock investing.

### SUMMARY OF THE INVENTION

The present invention provides an educational game apparatus and method for teaching both geography and principles of investing in stocks and commodities. The board has a multiplicity of triangular spaces forming a continuous path around the perimeter of the game board, and a map of a continent is disposed in a substantially central region of the board. A stack of investment cards each indicating a new value for a particular investment is included as part of the game. A plurality of stock value chips and at least two distinguishable player tokens for marking positions after moving along the continuous path are provided. Furthermore, there is a plurality of nation geography cards each containing at least one fact pertaining to the geography of a country of the continent. The game also includes a plurality of simulated paper currency in different denominations and a random number generator for randomly determining the number of spaces for individual players to move their player tokens.

A method for playing the game is also described.

### OBJECTS OF THE INVENTION

It is, therefore, one of the primary objects of the present invention to provide an enjoyable educational game for learning facts about the countries of a continent.

Another object of the present invention is to provide an inexpensive game apparatus that teaches players about the mineral resources of African countries.

Still another object of the present invention is to provide a game for multiple players to learn stock-market type investment principles.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is plan view of the game apparatus.

FIG. 2 is a partial plan view of a portion of the perimeter path and some investment cards.

### DESCRIPTION OF A PRESENTLY PREFERRED EMBODIMENT OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

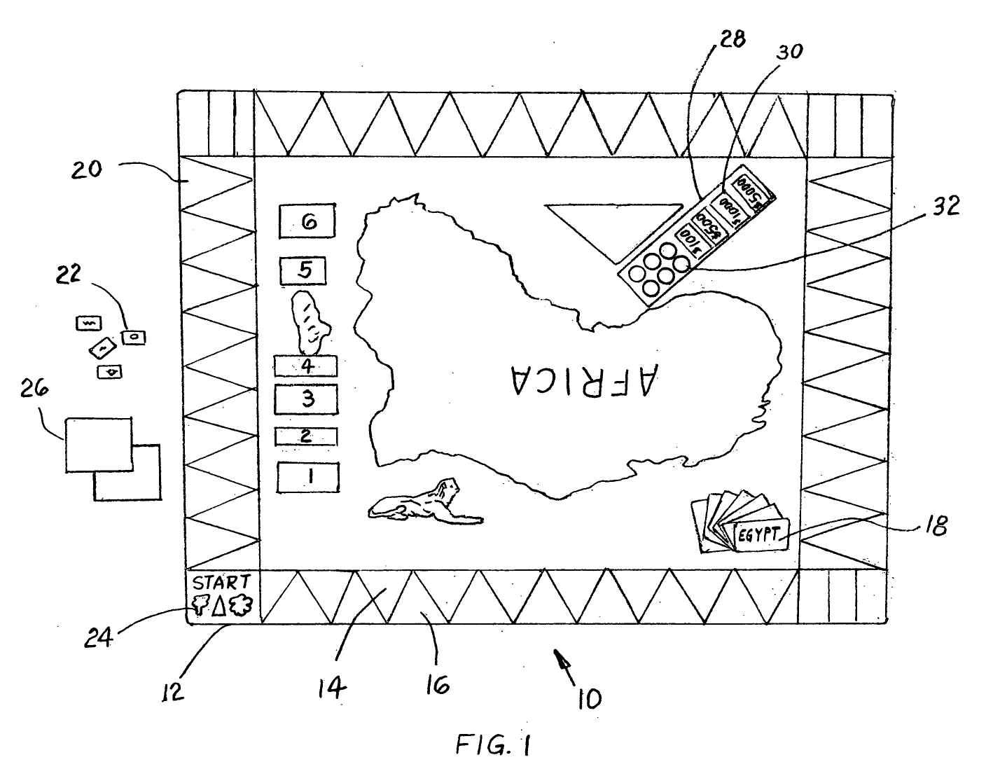

Referring initially to FIG. 1, the board game apparatus 10 is shown. The game board 12 in this case has a continuous path around the border composed of adjacent triangular spaces 14 and 16, alternating between the point being up and the point facing down. Some are labeled with the name of a country or region 14, while others 16 are labeled with the word “Invest”. Included are player tokens 24 and a random number generator, such as dice 22. There are also numerous stacks of numbered investment value cards 20 pertaining to various categories. Also, there is a deck of nation or region cards 18 that contain facts pertaining to the geography of that region or nation. Optionally, players acquire a simulated passport 26. In addition, there is a bank tray 28 of simulated money 30 in multiple denominations and stock value chips 32.

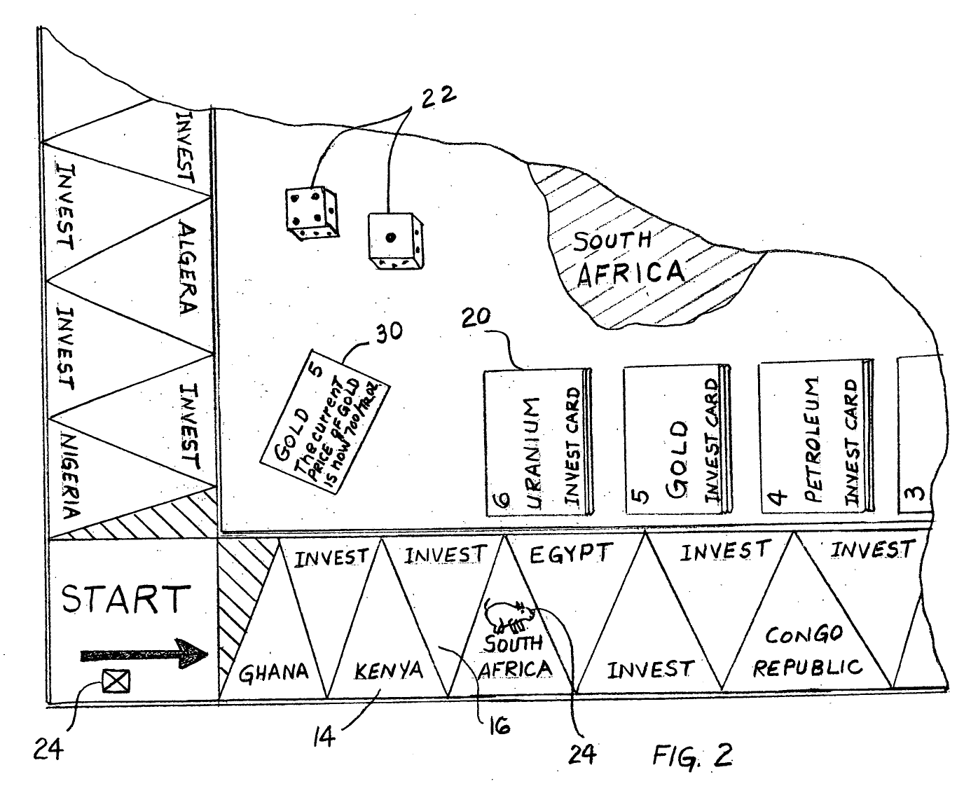

FIG. 2 provides a close-up view of one segment of the game apparatus, showing country triangles 14, and “Invest” triangles 16. The player tokens 24 are also shown, one on the start square and one on a country triangle. The numbered dice 22 is also displayed. Part of the face down investment cards 20 are illustrated as well. An example of a players turn is shown. The person has rolled a five, and advanced five spaces, landing on the South Africa triangle. The nation card for South Africa (not shown) indicated that the country is a producer of many resources, including gold, which happens to be assigned the number 5. Because the player rolled a five, that player has the option to purchase an amount of gold in exchange for simulated money at the price indicated on the front 30 of the top investment card from the Gold stack. A stock value chip is granted to the purchasing player.

Once that player elects what to do, the next player takes their turn starting with rolling the dice and moving their player token 24 the indicated number of triangular spaces. If they land on an “Invest” diamond, an investment value card 20 from the stack corresponding to the number rolled is turned over, and a new value is set for that investment. The player whose turn it is, if holding investments of that type, exchanges chips for ones of the new value. Players continue taking turns for a preselected duration of time or events. The value of each player's assets and money are then summed, and the player with the highest total is declared the winner. Alternatively, if only one player has sufficient financial resources to continue, the game ends.

While a presently preferred embodiment of the present invention has been described in sufficient detail above to enable a person skilled in the relevant art to make and use the same, it should be obvious that various other adaptations and modifications can be envisioned by those persons skilled in such art without departing from either the spirit of the invention or the scope of the appended claims.

We claim:

1. An educational investment board game apparatus comprising:
a) a substantially planar game board with a multiplicity of triangular spaces forming a continuous path around the perimeter of said game board, and a map of a continent in a substantially central region of said game board;
b) a plurality of investment cards each indicating a new value for a particular investment included as part of said board game apparatus;
c) at least two distinguishable player tokens for marking a position after moving along said continuous path;
d) a plurality of nation cards each containing at least one fact pertaining to the geography of one nation of said continent;
e) a plurality of stock value chips;
f) a plurality of simulated paper currency in different denominations; and
g) a random number generator for determining by chance a number of spaces for said player to move said player token.

2. The apparatus, according to claim 1, wherein said game apparatus includes simulated passports for players.

3. The apparatus, according to claim 1, wherein said random number generator is at least one numbered die.

4. The apparatus, according to claim 1, wherein said random number generator is a spinning arrow on a background of numbered spaces.

5. The apparatus, according to claim 1, wherein said continent is Africa.

6. A method of playing an educational investment game simulating investing in portions of a continent using a board game apparatus comprising (1) a substantially planar game board with a multiplicity of triangular spaces forming a continuous path around the perimeter of said game board, and a map of a continent in a substantially central region of said planar game board; (2) a stack of investment cards each indicating a new value for a particular investment included as part of said board game apparatus; (3) a plurality of stock value chips (4) at least two distinguishable player tokens for marking positions after moving along said continuous path; (5) a plurality of nation cards each containing at least one fact pertaining to geography of a nation of said continent; (6) a plurality of simulated paper currency in different denominations; and (7) a random number generator separate from said planar game board for randomly determining the number of spaces for said player to move said player token;
said method comprising the steps of:
a) providing each player with one of said distinguishable player tokens in a start square and equal amounts of said simulated currency;
b) arranging like numbered investment value cards face down into separate stacks on said game board;
c) designating a starting player as established by highest number from each player obtaining an initial value from said random number generator;
d) having said starting player followed by other players in turn use said random number generator and move corresponding player token accordingly;
e) having a player landing on a country space locate a geographical fact card for corresponding country and read one fact from said fact card;
f) having said player continue turn by selecting an investment value card from an investment category corresponding to result from use of random number generator;
g) allowing said player to purchase any affordable quantity of stock in said investment category at value stated on said investment value card by exchanging a corresponding amount of said simulated currency for one of corresponding said stock value chips;
h) requiring any player landing on a space labeled Invest to turn over top card from said stack corresponding to said result from random number generator, and requiring said player landing and holding said stock chips for indicated investment to exchange said stock chip for one equivalent to value shown on said top card;
i) having next player take a turn by using random number generator and moving corresponding player token by resulting number of spaces;
j) continuing play for a preselected duration of play;
k) concluding game by summing values of each player's simulated money and value of investment assets at current value; and
l) declaring player with highest said sum to be winner.

7. The method, according to claim 6, wherein said preselected duration of play corresponds to a predetermined number of trips around the board.

8. The method, according to claim 6, wherein said preselected duration of play is a time of play.
